(19) United States
(12) Patent Application Publication
(10) Pub. No.: US 2022/0129730 A1
(43) Pub. Date: Apr. 28, 2022

(54) PRIORITY DETERMINATION DEVICE, PRIORITY DETERMINATION METHOD, AND PRIORITY DETERMINATION SYSTEM

(71) Applicant: Hitachi, Ltd., Tokyo (JP)

(72) Inventor: Tejdeep Reddy HUNABAD, Tokyo (JP)

(73) Assignee: Hitachi, Ltd., Tokyo (JP)

(21) Appl. No.: 17/509,554

(22) Filed: Oct. 25, 2021

(30) Foreign Application Priority Data
Oct. 26, 2020 (JP) 2020-178917

(51) Int. Cl. G06N 3/04; G06N 3/08

(52) U.S. Cl. CPC G06N 3/0427; G06N 3/08

(57) ABSTRACT

Aspects relate to determining a priority based on impact on the surrounding environment according to the type of the event, thereby preventing the occurrence of secondary events resulting from the event and improving the efficiency and safety of event countermeasures in smart cities. Provided is a priority determination device including a sensor group for acquiring sensor information, an analysis unit for detecting, by analyzing the sensor information, occurrence of an event and determining an event feature related to the detected event, a surrounding impact determination unit for determining, for an impact region that has a possibility of being impacted by the event, a surrounding impact parameter that indicates an impact of the event on the impact region based on the event feature related to the event, and a priority calculation unit for determining a priority of the event based on at least the surrounding impact parameter.

### CROSS-REFERENCE TO RELATED APPLICATIONS

The present application claims priority to Japanese Patent Application No. 2020-178917, filed Oct. 26, 2020. The contents of this application are incorporated herein by reference in their entirety.

### BACKGROUND OF THE INVENTION

The present disclosure relates to a priority determination device, a priority determination method, and a priority determination system.

### SUMMARY OF THE INVENTION

In recent years, with the progress of IT, large numbers of sensors have been arranged throughout society, and extremely large amounts of data are accumulated. Against this background, Internet of Things (IoT) infrastructure services, which analyze collected data to create new value for society, are drawing attention. IoT can be applied to areas such as smart homes, smart buildings, smart cities, smart cars or connected cars, smart grids, healthcare, smart appliances, and advanced medical services through the integration and combination of conventional IT technologies and various industrial technologies.

As one part of IoT infrastructures, Command, Control, Communication, Computers, Intelligence (C4I) platforms that enhance the effectiveness of various services while protecting public safety are known. By applying the C4I platform to smart cities, it is possible to detect events such as traffic accidents, fires, terrorism, and natural disasters in real time, respond to these events, and implement countermeasures to suppress damage.

In such platforms, it is important to determine the priority of events in order to determine the most efficient way to deal with these events.

Conventionally, several proposals have been made to determine the priority of events.

For example, Japanese Unexamined Patent Application Publication No. 2016-057842 (Patent Document 1) describes an invention in which “A disaster response support system includes a disaster response support server and at least one portable terminal capable of recognizing its current position and capable of connecting to the disaster response support server via a communication line. The disaster response support server includes priority determination means for determining, when a report on the occurrence of a disaster is received from at least one portable terminal, the priority of a report relating to a work instruction, and a database for storing the received report information and priority information determined by the priority determination means. The priority determination means is configured to determine the priority of the disaster according to a reliability weighting coefficient acquisition means for obtaining a weighting coefficient according to a reliability determined based on a reporter of the report and a human casualty weighting coefficient acquisition means for obtaining a weighting coefficient according to additional information regarding the presence or absence of human casualties received together with the report.”

Patent Document 1 discloses a means for determining the priority of a disaster based on the reliability of the reporter who reported the disaster and the presence or absence of human casualties caused by the disaster.

However, the means described in Patent Document 1 focuses on determining the priority of a disaster according to the reliability of the report of the disaster, and does not anticipate determining priority based on the impact on an impact region which has a possibility of being impacted by the event according to the type of an event (fire, power failure, terrorism) such as a disaster or the like. Accordingly, when a plurality of events of the same type occur at different locations, for example, priority determination based on the impact on the impact region of the event cannot be performed, and an appropriate solution cannot be selected.

Accordingly, it is an object of the present disclosure to provide a priority determination means that is capable of determining a priority based on the impact on an impact region that has a possibility of being impacted by an event according to the type of the event (fire, power failure, terrorism), thereby preventing the occurrence of secondary events resulting from the event, and improving the efficiency and safety of event countermeasures in smart cities.

In order to solve the above problems, one representative priority determination device according to the present disclosure includes: a sensor group for acquiring sensor information; an analysis unit for detecting, by analyzing the sensor information using predetermined event determination rules, occurrence of an event and determining an event feature related to the detected event; a parameter calculation unit for calculating, with respect to an impact region that has a possibility of being impacted by the event, a static asset parameter that indicates an importance of static assets in the impact region and a dynamic asset parameter that indicates an importance of dynamic assets in the impact region; and a priority calculation unit for determining a priority of the event based on at least the static asset parameter and the dynamic asset parameter.

According to the present disclosure, it is possible provide a priority determination means that is capable of determining a priority based on the impact on an impact region that has a possibility of being impacted by an event according to the type of the event (fire, power failure, terrorism), thereby preventing the occurrence of secondary events resulting from the event, and improving the efficiency and safety of event countermeasures in smart cities.

Problems, configurations, and effects other than those described above will be made clear from the following description of embodiments for carrying out the invention.

### BRIEF DESCRIPTION OF THE DRAWINGS

FIG. 1 is a diagram illustrating an example of a hardware configuration of a priority determination device according to the embodiments of the present disclosure.

FIG. 2 is a diagram illustrating an example of a hardware configuration of a priority determination unit according to the embodiments of the present disclosure.

FIG. 3 is a diagram illustrating an example of an event response method according to the embodiments of the present disclosure.

FIG. 4 is a diagram illustrating an example of an event priority determination method according to the embodiments of the present disclosure.

FIG. 5 is a diagram illustrating an example of an event queue according to the embodiments of the present disclosure.

FIG. 6 is a diagram illustrating an example of a first database according to the embodiments of the present disclosure.

FIG. 7 is a diagram illustrating an example of a facility information database according to the embodiments of the present disclosure.

FIG. 8 is a diagram illustrating an example of a user input database according to the embodiments of the present disclosure.

FIG. 9 is a diagram showing an example of a second database according to the embodiments of the present disclosure.

FIG. 10 is a diagram illustrating a computer system for implementing the embodiments of the present disclosure.

### DETAILED DESCRIPTION

Hereinafter, embodiments of the present disclosure will be described with reference to the drawings. It should be noted that the present disclosure is not limited by these embodiments. Further, in the description of the drawings, the same parts are indicated by the same reference numerals.

As described above, in recent years, in smart cities equipped with IoT platforms, in order to determine the most efficient method of dealing with events such as fires, power outages, terrorism, and the like, determining the priority of the events is of great importance.

In conventional event priority determination means, the priority of events is classified into general categories such as “high,” “medium,” and “low.” However, in large-scale environments such as smart cities, where a large number of events occur, the same level of priority may be assigned to multiple events, such that it becomes unclear which events should be prioritized. Accordingly, in order to determine the countermeasures that most efficiently respond to the large number of events occurring in a smart city with limited resources, a means of determining finer priorities is required.

In addition, in some situations, if an event is not immediately responded to, a secondary event resulting from the event may occur, leading to serious damage. As an example, if a fire occurs in the vicinity of a gasoline station, the fire may spread to the gasoline station and cause an explosion or the like unless fire extinguishing activities are promptly carried out.

In view of situations such as those mentioned above, there is a need for a means of determining fine priorities based on the impact on an impact region that has a possibility of being impacted by the event according to the type of the event (fire, power failure, terrorism).

As an example, in the case that a fire occurs simultaneously in a park and at gasoline station, in consideration of the surrounding environment and population density of the location where the fire occurred, it is desirable to give priority to responding to the fire that has occurred in the vicinity of the gasoline station in order to prevent the occurrence of secondary events such as explosions in the case that the fire spreads to the gasoline station.

Accordingly, in the present disclosure, a fine priority is determined using a surrounding impact parameter determined for an impact region that has a possibility of being impacted by an event in addition to a criticality parameter that indicates the current criticality of the event. In the present disclosure, priority refers to is a measure that quantitatively indicates the degree to which a particular event is prioritized, and the higher the priority of an event, greater speed and more resources (human resources, physical resources, financial resources) should be used to respond in comparison to other events.

In addition, events in the present disclosure refer to events that may have a significant impact on smart cities, and may include, for example, fires, power outages, terrorism, traffic accidents, infectious diseases, natural disasters (tornados, earthquakes, tsunamis, typhoons), and the like.

According to the present disclosure, it is possible to prevent the occurrence of secondary events resulting from an event and improve the efficiency and safety of event countermeasures in smart cities.

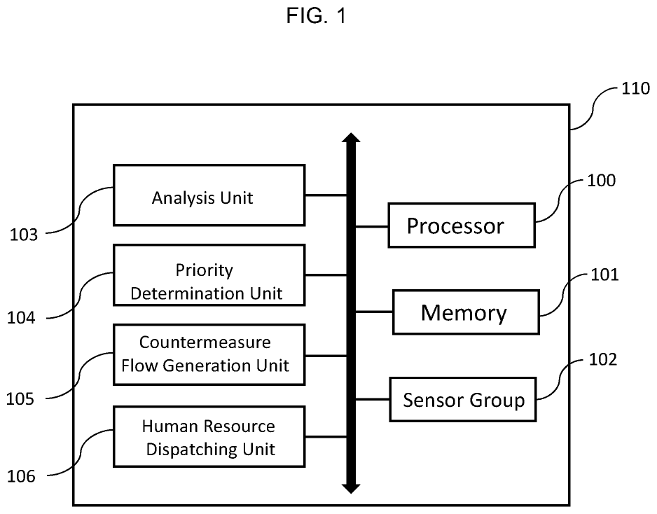

First, with reference to FIG. 1, a hardware configuration of a priority determination device according to the embodiments of the present disclosure will be described.

FIG. 1 is a diagram showing an example of a hardware configuration of a priority determination device 110 according to an embodiment of the present disclosure.

As illustrated in FIG. 1, the priority determination device 110 includes a processor 100 and a memory 101 for executing various processes in the functions according to the embodiments of the present disclosure, a sensor group 102 for acquiring sensor information, an analysis unit 103, a priority determination unit 104, a countermeasure flow generation unit 105, and a human resource dispatching unit 106.

The sensor group 102 is arranged in a smart city, and is a sensor network for acquiring sensor information about the smart city. For example, the sensor group 102 may include sensors configured to acquire data indicating observation results related to various aspects of the smart city as sensor information, such as video information, audio information, temperature information, motion information of an object, air pressure information, humidity information, acceleration information, photovoltaic power generation information, traffic information, crime prevention information, traffic light information, disaster information, sunlight information, rainfall amount information, wind direction information, air volume information, wind speed information, wind pressure information, depth information, and the like.

The sensor group 102 continuously acquires sensor information about the smart city and transmits the information to the analysis unit 103.

The analysis unit 103 is a functional unit for receiving the sensor information acquired by the sensor group 102 and analyzing the sensor information using predetermined event determination rules to detect the occurrence of an event and determine event features related to the detected event. Here, the event features are information indicating characteristics necessary for identifying an event and efficiently dealing with the event.

The analysis unit 103 here may be, for example, a neural network trained to detect an event based on the sensor information. In this case, the neural network functioning as the analysis unit 103 may be trained by an existing method, and is not particularly limited as long as it can detect events with high accuracy.

In addition, the event determination rules are rules that are predetermined by the user of the priority determination device 110, for example, and define, for each of a variety of events that have a possibility of occurring, criteria used for detecting the events. For example, as a determination rule for determining a fire, “whether a predetermined number of fire alarms within a predetermined area have been activated” or “the temperature exceeds a predetermined value” or the like may be considered. In addition, in the case that the analysis unit 103 is configured with a neural network trained to detect events based on sensor information, the event determination rules may be the parameters of the neural network set to detect each event.

It should be noted that the analysis unit 103 may have not only a function for detecting events from sensor information, but also a function for detecting events reported by a citizen of a smart city or the like.

The priority determination unit 104 is a functional unit for determining the priority of an event based on event features determined for the event. More particularly, the priority determination unit 104 determines, as the priority of an event, a value in the range of 0 to 100 based on a criticality parameter that indicates the criticality of the event and a surrounding impact parameter that indicates the impact on an impact region that has a possibility of being impacted by the event (here, the greater the priority value, the higher the priority). Accordingly, by expressing the priority using a finer scale, such as a value in the range of 0 to 100, rather than a general priority category such as “high,” “medium,” and “low,” for example, even if a plurality of events occurred at the same time, it is possible to determine an appropriate priority for each event and to efficiently implement countermeasure flows corresponding to these events.

In addition, here, the impact region refers to a region that has a possibility of being harmed by an event. In addition, the impact region may be set by, for example, a radius of the impact region stored in the user input database 207, which will be described later. As an example, in the case that the radius of the impact region is “300 meters,” a region within a radius of 300 meters from the location where the event occurs is set as the “impact region” that has a possibility of being impacted by the event.

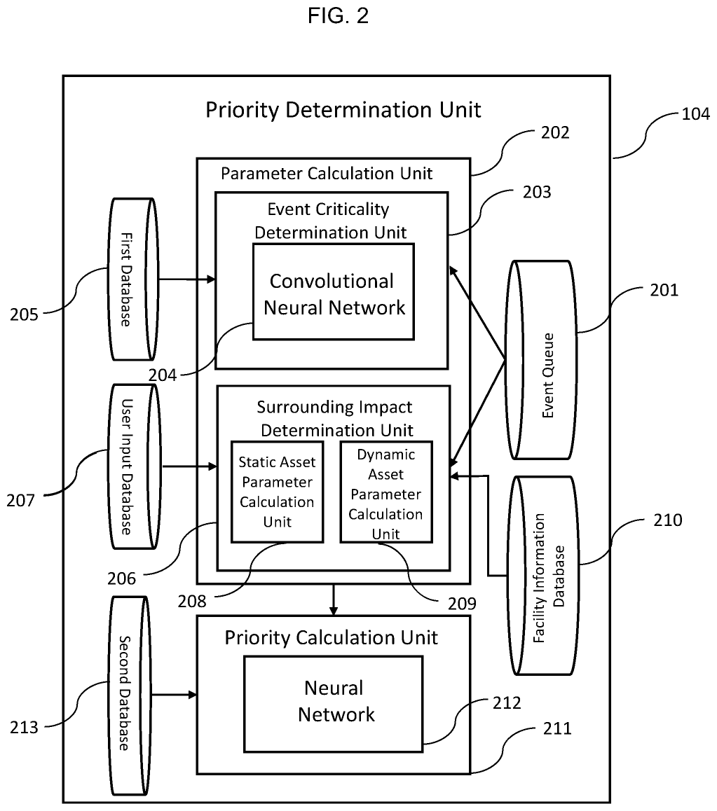

It should be noted that the configuration and the functions of the priority determination unit 104 will be described with reference to FIG. 2, and thus the description thereof will be omitted here.

The countermeasure flow generation unit 105 is a functional unit for generating a countermeasure flow for dealing with an event based on the priority determined by the priority determination unit 104. With respect to events having a higher priority, the countermeasure flow generation unit 105 generates a countermeasure flow that is faster and uses more resources (human resources, physical resources, financial resources, or the like). Here, the countermeasure flow refers to a sequence of actions to prevent damage caused by events, to prevent the occurrence of secondary events resulting from events, and to minimize the impact of events. The countermeasure flow is not limited to actions performed by humans, but also includes actions performed automatically by predetermined systems, artificial intelligence, or robots.

As an example, in the case that an event of “fire” occurs, the countermeasure flow may include an action of “evacuate humans and animals within a predetermined distance from the location where the fire occurred” and an action of “dispatch a fire brigade.”

The human resource dispatching unit 106 is a functional unit for procuring and dispatching the human resources necessary for implementing a countermeasure flow based on the countermeasure flow generated by the countermeasure flow generation unit 105. For example, in the case that an event of “fire” occurs, and the countermeasure flow defines an action of “evacuate humans and animals within a predetermined distance from the location where the fire occurred” and an action of “dispatch a fire brigade,” the human resource dispatching unit 106 may dispatch police officers to evacuate humans and animals, and dispatch a fire brigade to carry out fire extinguishing activities.

According to the priority determination device 110 configured as illustrated in FIG. 1, by determining a priority based on the impact on an impact region that has a possibility of being impacted by an event according to the type of the event (fire, power failure, terrorism), the occurrence of secondary events resulting from the event can be prevented, and the efficiency and safety of event countermeasures in smart cities can be improved.

Next, with reference to FIG. 2, a hardware configuration of the priority determination unit according to the embodiments of the present disclosure will be described.

FIG. 2 is a diagram illustrating an example of a hardware configuration of the priority determination unit 104 according to the embodiments of the present disclosure. As described above, the priority determination unit 104 is a functional unit for determining the priority of an event based on an event feature related to the event.

As illustrated in FIG. 2, the hardware configuration of the priority determination unit 104 includes an event queue 201, a parameter calculation unit 202, an event criticality determination unit 203, a convolutional neural network 204, a first database 205, a surrounding impact determination unit 206, a user input database 207, a static asset parameter calculation unit 208, a dynamic asset parameter calculation unit 209, a facility information database 210, a priority calculation unit 211, a neural network 212, and a second database 213.

The event queue 201 is a database in which the information of events detected by the analysis unit (for example, the analysis unit 103 illustrated in FIG. 1) according to the embodiments of the present disclosure is stored. The event queue 201 stores the event features of the events detected by the analysis unit. As will be described later, the priority of the events can be determined based on the event information stored in the event queue 201.

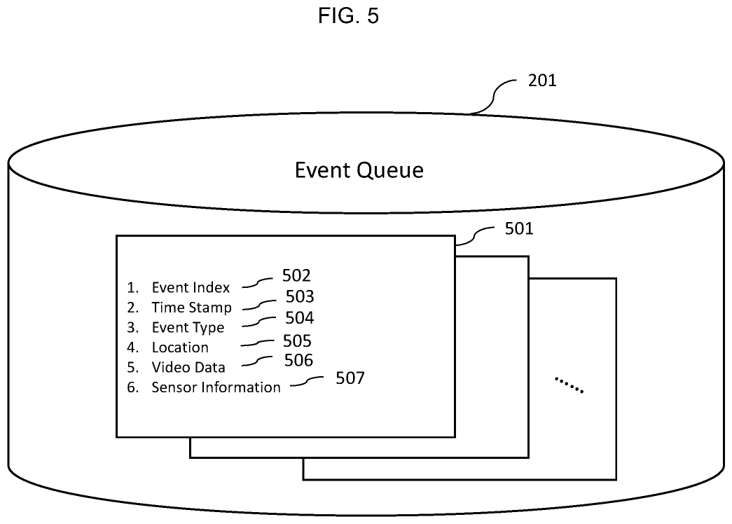

It should be noted that the details of the event queue 201 will be described with reference to FIG. 5.

The parameter calculation unit 202 includes an event criticality determination unit 203 for determining the criticality parameter for each event stored in the event queue 201, and a surrounding impact determination unit 206 for determining the surrounding impact parameter (including the static asset parameter and the dynamic asset parameter).

The event criticality determination unit 203 is a functional unit for determining, for each event stored in the event queue 201, a criticality parameter that indicates the criticality of the event. In order to determine the criticality of an event, the event criticality determination unit 203 may use, for example, a convolutional neural network 204 that has been trained to calculate the criticality of the event. The convolutional neural network 204 may be trained by training data stored in the first database 205, for example.

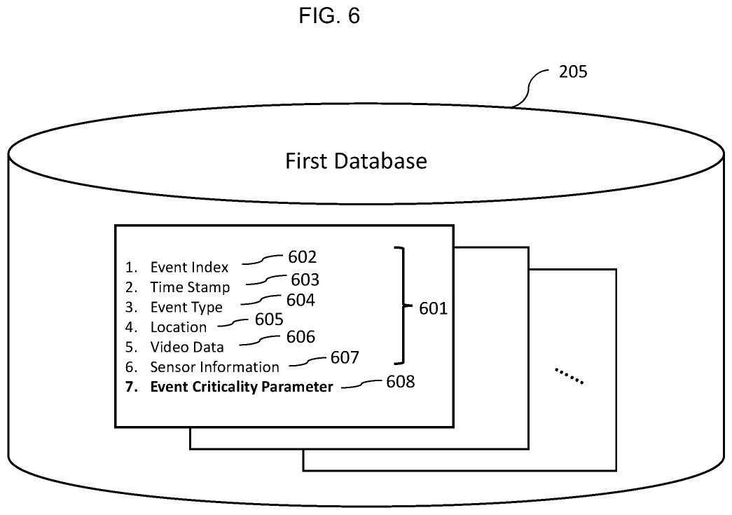

It should be noted that the details of the first database 205 that stores the training data used for training the convolutional neural network 204 will be described with reference to FIG. 6.

The surrounding impact determination unit 206 is a functional unit for determining, for each event stored in the event queue 201, a surrounding impact parameter that indicates the impact on an impact region that has a possibility of being impacted by the event. The surrounding impact parameter is a value that indicates the degree of impact of the event on the impact region, and may be determined based on the static asset parameter and the dynamic asset parameter calculated based on the information stored in the event queue 201, the user input database 207, and the facility information database 210.

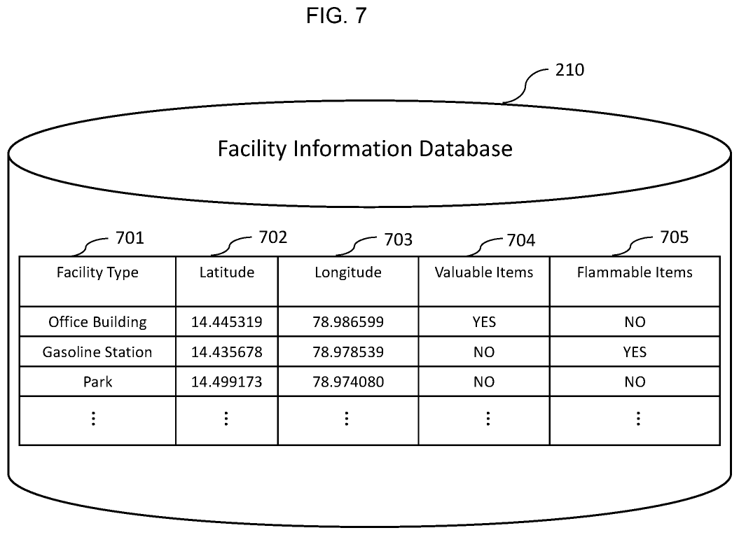

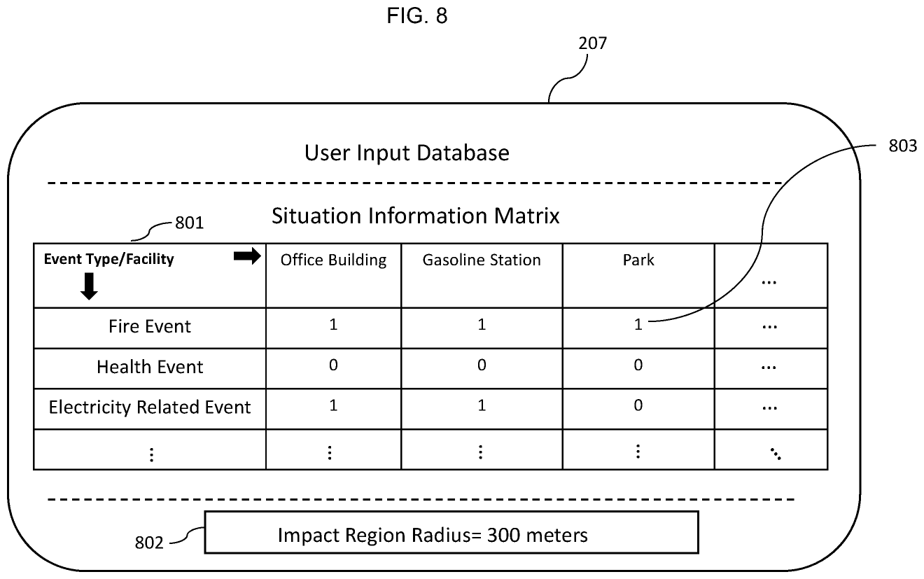

It should be noted that the details of the facility information database 210 and the user input database 207 will be described with reference to FIG. 7 and FIG. 8, which will be described later.

In some embodiments, the surrounding impact parameter determined by the surrounding impact determination unit 206 may be determined based on the static asset parameter calculated by the static asset parameter calculation unit 208 and the dynamic asset parameter calculated by the dynamic asset parameter calculation unit 209.

The static asset parameter calculation unit 208 is a functional unit for calculating a static asset parameter that indicates the importance of the static assets in the impact region of the event. Here, static assets refer to things in the impact region of the event that do not change state unless changed by external forces, and include, for example, buildings, goods, infrastructure, personal and corporate assets, cash, or the like that exists in the impact region of the event. The static asset parameter calculation unit 208 may calculate the static asset parameter based on the information stored in the event queue 201, the user input database 207, and the facility information database 210.

The dynamic asset parameter calculation unit 209 is a functional unit for calculating a dynamic asset parameter that indicates the importance of the dynamic assets in the impact region of the event. Here, dynamic assets refer to things in the impact region of the event whose state changes by its own force, and include, for example, living bodies such as humans or animals, and machines that move automatically, such as automobiles, trains, robots, or the like. The dynamic asset parameter calculation unit 209 may calculate the dynamic asset parameter based on the information stored in the event queue 201, the user input database 207, and the facility information database 210.

The priority calculation unit 211 is a functional unit for calculating the priority of an event based on an event criticality parameter calculated by the event criticality determination unit 203 of the parameter calculation unit 202 and the surrounding impact parameter calculated by the surrounding impact determination unit 206. To determine the priority of the event, the priority calculation unit 211 may use, for example, a neural network 212 trained to calculate the priority of events. The neural network 212 may be trained using training data stored in the second database 213, for example.

The neural network 212 here, for example, is a multilayer perceptron (MLP) network consisting of an input layer, a plurality of hidden layers, and an output layer. The input layer of the neural network 212 inputs, for example, the event features determined by the analysis unit, the event criticality parameter determined by the event criticality determination unit 203, and the surrounding impact parameter determined by the surrounding impact determination unit 206. Next, the hidden layers calculate the priority of the event by processing the input information using an activation function such as a Rectified Linear Unit (ReLU). Next, the output layer uses a sigmoidal function to set the output of the hidden layers to a value between “0” and “1,” and outputs this value as the priority of the event. This priority may be a value between “0” and “1” or may be converted to a value between “0” and “100.”

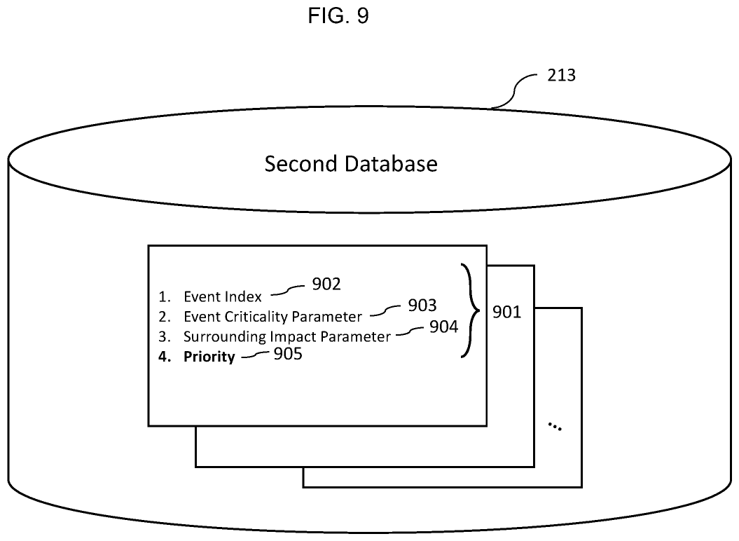

It should be noted that the details of the second database 213 that stores the training data used for training the neural network 212 will be described with reference to FIG. 9.

According to the priority determination unit 104 configured as illustrated in FIG. 2, it is possible to determine priority based on the impact on the impact region according to the type of the event (fire, power failure, terrorism).

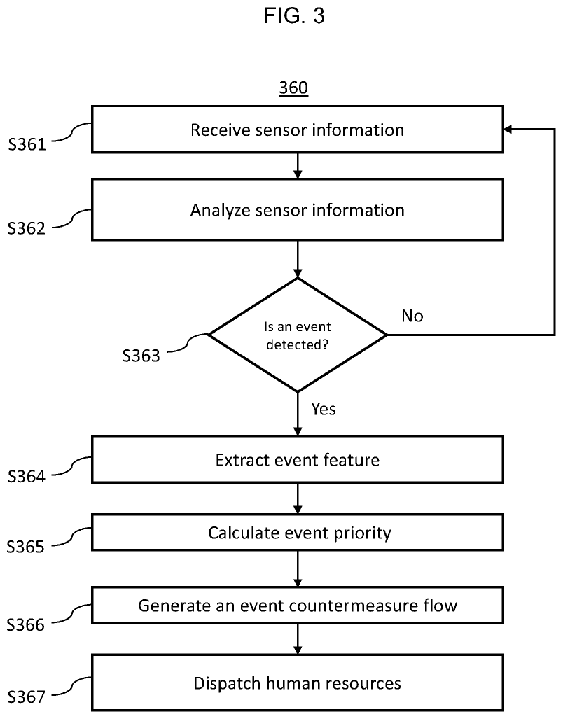

Next, with reference to FIG. 3, the event response method according to the embodiments of the present disclosure will be described.

FIG. 3 is a diagram illustrating an example of an event response method 360 according to an embodiment of the present disclosure; The event response method 360 illustrated in FIG. 3 is a method for performing a response for suppressing the impact of an event that occurs in the smart city, and is, for example, a method implemented by the priority determination device 110 illustrated in FIG. 1.

First, in Step S361, the analysis unit (for example, the analysis unit 103 illustrated in FIG. 1) receives sensor information relating to the smart city from a group of sensors (for example, the sensor group 102 illustrated in FIG. 1) arranged in the smart city.

For example, here, the analysis unit may receive, as the sensor information, an image from a security camera installed in a park and a thermal image from a thermal camera installed in the park.

Next, in Step S362, the analysis unit detects an event by analyzing the sensor information received in Step S361 using the predetermined event determination rules. For example, in the case that, in addition to detecting a region that exceeds a predetermined temperature by analyzing a thermal image received from a thermal camera using a predetermined image analysis means, the analysis unit also detects that a burning permit corresponding to the current date and time and the location of the park has not been registered in advance, an event of “fire” may be determined.

Next, in Step S363, in the case that no event is detected, the processing returns to Step S361, and in the case that an event is detected, the processing proceeds to Step S364.

In the case that an event is detected in Step S363, in Step S364, the analysis unit extracts event features for the detected event, and stores these event features as event information in the event queue (for example, the event queue 201 illustrated in FIG. 5).

Here, the analysis unit may save, as event features in the event queue, an event index for uniquely identifying the event, a time stamp indicating the time when the event occurred, an event type indicating the type of the event (fire, traffic accident), the location where the event occurred (latitude and longitude), and video data indicating the state of the event, for example.

Next, in Step S365, the priority determination unit (for example, the priority determination unit 104 illustrated in FIG. 1) determines the priority of the events determined in Step S362 to Step S363. As described above, here, the priority determination unit may determine the priority of the events based on the criticality parameter calculated for the event and the surrounding impact parameter. For example, the priority determination unit may calculate a value in the range of 0 to 100 as the priority of the event.

Next, in Step S366, the countermeasure flow generation unit (for example, the countermeasure flow generation unit 105 illustrated in FIG. 1) generates a countermeasure flow for responding to the event based on the event priority determined in Step S365. Here, the countermeasure flow generation unit may select, from among predetermined countermeasure flow candidates for each event type, a countermeasure flow for implementing a countermeasure flow candidate corresponding to the priority of the event. In addition, in embodiments, the countermeasure flow generation unit may select countermeasure flow candidates that are faster and use more resources (human resources, physical resources, financial resources, or the like) for higher priority events. Further, in the case that there are a plurality of countermeasure flow candidates corresponding to the event priority for one event type, the countermeasure flow generation unit may select the countermeasure flow that is most likely to suppress the event while investing the currently available human resources, physical resources, and financial resources in the most efficient manner.

Next, in Step S367, the human resource dispatching unit (for example, the human resource dispatching unit 106 illustrated in FIG. 1) procures and dispatches the human resources required to implement the countermeasure flows generated in Step S366. As described above, for example, in the case that an event of “fire” occurs, and the countermeasure flow defines an action of “evacuate humans and animals within a predetermined distance from the location where the fire occurred” and an action of “dispatch a fire brigade,” the human resource dispatching unit may dispatch police officers to evacuate humans and animals, and dispatch a fire brigade to carry out fire extinguishing activities.

According to the event response method 360 described above, it is possible to determine priority based on the impact on the surrounding environment according to the type of the event (fire, power failure, terrorism) and efficiently respond to the event according to the determined priority.

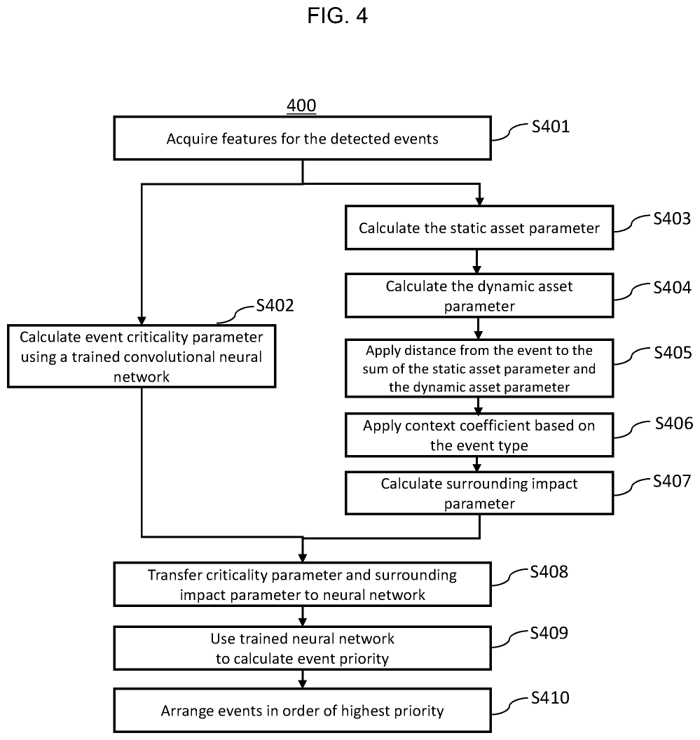

Next, with reference to FIG. 4, an event priority determination method according to the embodiments of the present disclosure will be described.

FIG. 4 is a diagram illustrating an example of an event priority determination method 400 according to the embodiments of the present disclosure. The event priority determination method 400 illustrated in FIG. 4 is a method for determining the priority of an event that has occurred in a smart city, and is, for example, a method executed by each functional unit of the priority determination unit 104 illustrated in FIG. 1.

It should be noted that the event priority determination process 400 illustrated in FIG. 4 corresponds to Step S365 for calculating the event priority, illustrated in FIG. 3. In addition, although a case is described as an example herein in which the priority for one event is determined, it is needless to say that the following steps can be executed with respect to a plurality of events to determine the priority for a plurality of events.

First, in Step S401, the priority determination unit acquires the features extracted for the events detected by the analysis unit from the event queue (for example, the event queue 201 illustrated in FIG. 2.) For example, as described above, the priority determination unit may acquire event features from the event queue such as an event index for uniquely identifying the event, a time stamp indicating the time when the event occurred, an event type indicating the type of the event (fire, traffic accident), the location where the event occurred (latitude and longitude), and video data indicating the state of the event, for example.

Next, the priority determination unit transfers the acquired event features to the event criticality determination unit of the parameter calculation unit (for example, the event criticality determination unit 203 illustrated in FIG. 2) and the surrounding impact determination unit (for example, the surrounding impact determination unit 206 illustrated in FIG. 2).

In Step S402, the event criticality determination unit uses a trained convolutional neural network (for example, the convolutional neural network 204 illustrated in FIG. 2) to calculate the criticality parameter of the event based on the event features acquired in Step S401. As described above, the criticality parameter here is a criticality parameter that indicates the criticality of the event, and may be expressed by a value in the range from 0 to 100, for example.

In Step S403, the static asset parameter calculation unit (for example, the static asset parameter calculation unit 208 illustrated in FIG. 2) of the surrounding impact determination unit calculates a static asset parameter indicating the importance of the static assets of each respective facility in the impact region of the event. Here, the static asset parameter calculation unit calculates the static asset parameter based on the event features acquired in Step S401 and the facility information database (for example, the facility information database 210 illustrated in FIG. 2). More particularly, for example, the static asset parameter calculation unit calculates the static asset parameter by estimating, for each facility in the impact region of the event, the monetary value of the static assets that are likely to be harmed by the event based on the event features and the information stored in the facility information database.

In Step S404, the dynamic asset parameter calculation unit (for example, the dynamic asset parameter calculation unit 209 illustrated in FIG. 2) of the surrounding impact determination unit calculates a dynamic asset parameter indicating the importance of the dynamic assets of each respective facility in the surrounding environment of the event. Here, the dynamic asset parameter calculation unit calculates the dynamic asset parameter based on the event features acquired in Step S401 and information indicating the dynamic assets in the impact region of the event. More particularly, for example, the dynamic asset parameter calculation unit calculates the dynamic asset parameter by estimating, for each facility in the impact region of the event, the number of dynamic assets (the number of robots, automobiles, animals, people, or the like) that are likely to be harmed by the event based on population density information for the impact region (statistical information of the population density based on a national census, the number of people estimated from video data included in the sensor information or the like).

In Step S405, the surrounding impact determination unit calculates the sum of the static asset parameters for each facility calculated in Step S403 and the dynamic asset parameters for each facility calculated in Step S404, and divides this sum by the distance of the surrounding environment from the event.

In Step S406, the surrounding impact determination unit applies a context coefficient based on the event type to the value obtained in Step S405. The context factor here is a binary type parameter that indicates, in consideration of the event type of the event, whether or not a facility existing in the impact region of the event will be harmed by an event. The context coefficient is “1” in the case that the facility existing in the impact region of the event is harmed by the event, and the context coefficient is “0” in the case that the facility existing in the impact region of the event is not harmed by the event.

The context coefficient is determined based on the situation information matrix illustrated in FIG. 8. The details of the context coefficient and the situation information matrix will be described later with reference to FIG. 8.

In Step S407, the surrounding impact determination unit calculates the surrounding impact parameter for the surrounding environment by summing the values calculated for the respective facilities existing in the impact region of the event (the result of the calculation of Step S403 to Step S406). Here, the surrounding impact parameter of the surrounding environment is a value that quantitatively indicates the degree of impact on the impact region of the event, and may be expressed by a value in the range of 0 to 100, for example.

The process for calculating the surrounding impact parameter described in the above Steps S403 to S407 is illustrated in Equation 1 below.

$$S A P P = \sum i ( C k i ) ( \frac{S i}{D i} ) \qquad [ Equation 1 ]$$

Here, SAPP is the surrounding impact parameter, i is a particular facility, Si is the sum of the static asset parameter and the dynamic asset parameter of the facility i, Di is the distance of the facility i from the event, and Cki is the context coefficient of the facility i.

Consider, as an example, a case in which an event having an event type of “fire” occurs in a smart city. It is assumed that the radius of the impact region is set as 300 meters from the location of occurrence of the event. In this case, facilities within 300 meters from the location of occurrence of the event are included in the calculation of the surrounding impact parameter. For example, within 300 meters of the event, facilities such as office buildings, gasoline stations, and parks may exist.

First, as described above, the static asset parameter and the dynamic asset parameter are calculated for the three facilities of the office building, the gasoline station, and the park, and the sum (Si) thereof is calculated. In addition, the distance (Di) of each facility from the event is determined. Subsequently, for each facility, context coefficients (Cki) are determined from the situation information matrix illustrated in FIG. 8. In this case, as indicated by the situation information matrix illustrated in FIG. 8, all three facilities of the office building, the gas station, and the park are impacted by an event of the event type of “fire,” and so the context coefficient of each facility becomes “1”.

Subsequently, as illustrated in Equation 1, for each facility, the sum Si of the static asset parameter and the dynamic asset parameter, the inverse of the distance Di from the event, and the context coefficient Cki are multiplied, and the sum of the products obtained for each facility is calculated, thereby obtaining the surrounding impact parameter SAPP.

Next, in Step S408, the criticality parameter calculated in S402 and the surrounding impact parameter calculated in Steps S403 to S407 are transferred to the neural network (for example, the neural network 212 illustrated in FIG. 2).

Next, in Step S409, the priority calculation unit (for example, the priority calculation unit 211 illustrated in FIG. 2) calculates the priority of the event based on the transferred criticality parameter and the surrounding impact parameter using the neural network.

In Step S410, the priority calculation unit arranges the events in order of highest priority. As described above, the priorities determined here are used in generating the event countermeasure flow.

According to the event priority determination method 400 described above, it is possible to determine priority based on the impact on the surrounding environment according to the type of the event (fire, power failure, terrorism) and efficiently respond to the event according to the determined priority.

Next, an event queue according to the embodiments of the present disclosure will be described with reference to FIG. 5.

FIG. 5 is a diagram illustrating an example of an event queue 201 according to the embodiments of the present disclosure. Here, the event queue 201 is a database for storing event information 501 that relates to the events detected by the above-described analysis unit (for example, the analysis unit 103 illustrated in FIG. 1). The event queue 201 may store different event information 501 for each event detected by the analysis unit.

Here, the event information 501 is information that indicates the features related to a detected event. As described above, here, the event features refer to characteristics necessary for identifying and efficiently dealing with an event, and as illustrated in FIG. 5, may include an event index 502 for uniquely identifying the event, a time stamp 503 indicating the time when the event occurred, an event type 504 indicating the type of the event (fire, traffic accident), a location 505 where the event occurred (latitude and longitude), video data 506 indicating the state of the event, and sensor information 507 acquired by the sensors.

As described above, the priority determination unit (for example, the priority determination unit 104 illustrated in FIG. 1) according to the embodiments of the present disclosure can determine the priority of an event based on the event information 501 stored in the event queue 201.

Next, with reference to FIG. 6, a first database according to the embodiments of the present disclosure will be described.

FIG. 6 is a diagram illustrating an example of the first database 205 according to the embodiments of the present disclosure. The first database 205 is a database for storing training data 601 for training the above-described convolutional neural network (for example, the convolutional neural network 204 illustrated in FIG. 2).

The training data 601 is information for training the convolutional neural network according to the embodiments of the present disclosure, and as illustrated in FIG. 6, may include an event index 602 for uniquely identifying an event, a time stamp 603 indicating the time when the event occurred, an event type 604 indicating the type of the event (fire, traffic accident), a location 605 where the event occurred (latitude and longitude), video data 606 indicating the state of the event, and sensor information 607 acquired by the sensors.

It should be noted that the training data 601 here may be event features acquired for past events.

By training the convolutional neural network according to the embodiments of the present disclosure based on the training data 601 stored in the first database 205 illustrated in FIG. 6, the convolutional neural network 204 can calculate the criticality parameter 608 of the event. After the criticality parameter 608 of the event has been calculated, this criticality parameter of the event is stored in the first database 205.

Next, with reference to FIG. 7, a facility information database according to the embodiments of the present disclosure will be described.

FIG. 7 is a diagram illustrating an example of the facility information database 210 according to the embodiments of the present disclosure. The facility information database 210 is a database for storing information regarding the facilities in the surrounding environment of an event. The information stored in the facility information database 210 is used, for example, in determining the surrounding impact parameter of an event.

It should be noted that the facility information database 210 may be created in advance by the user.

As illustrated in FIG. 7, the facility information database 210 includes facility type information 701 indicating the type of the facility, facility latitude information 702, facility longitude information 703, valuable item information 704 indicating the presence or absence of valuable items in the facility, and flammable item information 705 indicating the presence or absence of flammable items in the facility.

It should be noted that the presence or absence of valuable items and the presence or absence of flammable items may be determined by a predetermined criterion. As an example, in embodiments, if assets equivalent to 100,000 yen or more are stored at a facility, the facility may be determined to have valuable items, and if assets equivalent to less than 100,000 yen are stored, the facility may be determined to have no valuable items.

By using the information stored in the facility information database 210 illustrated in FIG. 7, it is possible to calculate the static asset parameter and the dynamic asset parameter used to calculate the priority of an event.

Next, with reference to FIG. 8, a user input database according to the embodiments of the present disclosure will be described.

FIG. 8 is a diagram illustrating an example of the user input database 207 according to the embodiments of the present disclosure. The user input database 207 illustrated in FIG. 8 is a database for storing information input by the user of the priority determination device according to the embodiments of the present disclosure.

As illustrated in FIG. 8, the user input database 207 includes a situation information matrix 801 and an impact region radius 802.

The situation information matrix 801 is a data structure that indicates, for each event type, whether a particular facility is impacted by an event, and is used to determine the context coefficient 803 described above. If a facility is impacted by a particular event type, the context coefficient 803 becomes “1” and if a facility is not impacted by a particular event type, the context coefficient 803 becomes “0.” For example, in the case of an event type of “fire,” the three facilities of the office building, the gasoline station, and the park are impacted, and the context coefficient 803 of each facility becomes “1.” On the other hand, in the case of an event type of “power failure,” since the office building and the gasoline station are impacted by the power failure, the context coefficient 803 of these facilities becomes “1,” but since the park is not impacted by the power failure, the context coefficient 803 of the park becomes “0.”

The impact region radius 802 is information that indicates the radius of the region impacted by the event. As an example, in the case that the impact region radius is “300 meters,” a region within a radius of 300 meters from the location of the event is set as the “impact region” that has a possibility of being impacted by the event.

It should be noted that the impact region radius 802 of the impact region may be estimated by the user, or may be determined based on the impact region radius of past events, for example.

As described above, by using the situation information matrix 801 and the impact region radius 802 included in the user input database 207 illustrated in FIG. 8, the surrounding impact parameter can be calculated.

Next, with reference to FIG. 9, a second database according to the embodiments of the present disclosure will be described.

FIG. 9 is a diagram illustrating an example of the second database 213 according to the embodiments of the present disclosure. Here, the second database 213 is a database for storing training data 901 for training the above-described neural network (for example, the neural network 212 illustrated in FIG. 2).

Here, the training data 901 is information for training the neural network according to the embodiments of the present disclosure, and, as illustrated in FIG. 9, includes an event index 902 for uniquely identifying an event, a criticality parameter 903 for the event, and a surrounding impact parameter 904 of the event.

It should be noted that here, the training data 901 may be parameters calculated for past events.

By training the neural network according to the embodiments of the present disclosure with the training data 901 stored in the second database 213 illustrated in FIG. 9, the neural network can calculate the priority 905 events. After the priority 905 of an event is calculated, the priority 905 of the event is stored in the second database 213.

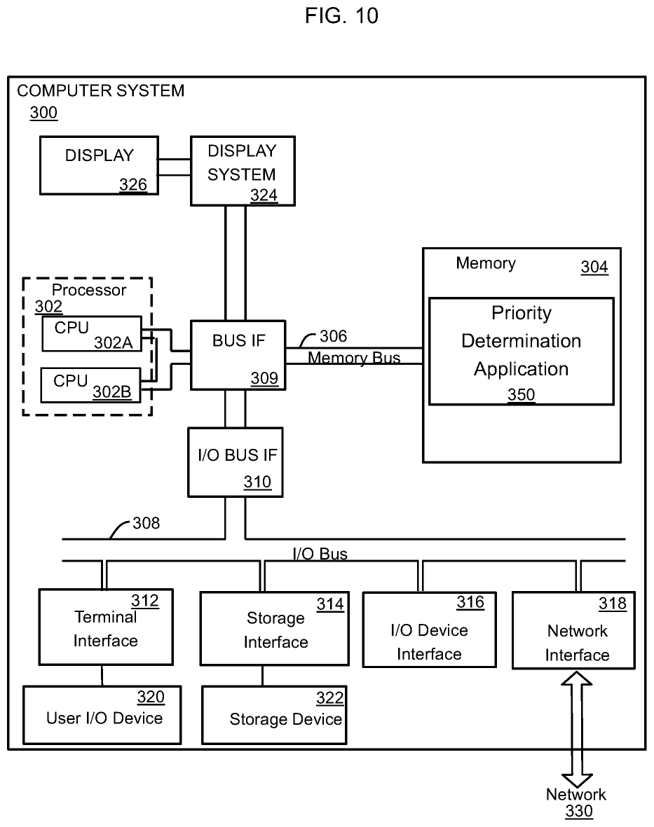

Referring now to FIG. 10, a computer system 300 for implementing the embodiments of the present disclosure will be described. The mechanisms and devices of the various embodiments disclosed herein may be applied to any suitable computing system. The main components of the computer system 300 include one or more processors 302, a memory 304, a terminal interface 312, a storage interface 314, an I/O (Input/Output) device interface 316, and a network interface 318. These components may be interconnected via a memory bus 306, an I/O bus 308, a bus interface unit 309, and an I/O bus interface unit 310.

The computer system 300 may include one or more general purpose programmable central processing units (CPUs), 302A and 302B, herein collectively referred to as the processor 302. In some embodiments, the computer system 300 may contain multiple processors, and in other embodiments, the computer system 300 may be a single CPU system. Each processor 302 executes instructions stored in the memory 304 and may include an on-board cache.

In some embodiments, the memory 304 may include a random access semiconductor memory, storage device, or storage medium (either volatile or non-volatile) for storing data and programs. The memory 304 may store all or a part of the programs, modules, and data structures that perform the functions described herein. For example, the memory 304 may store a priority determination application 350. In some embodiments, the priority determination application 350 may include instructions or statements that execute the functions described below on the processor 302.

In some embodiments, the priority determination application 350 may be implemented in hardware via semiconductor devices, chips, logic gates, circuits, circuit cards, and/or other physical hardware devices in lieu of, or in addition to processor-based systems. In some embodiments, the priority determination application 350 may include data other than instructions or statements. In some embodiments, a camera, sensor, or other data input device (not shown) may be provided to communicate directly with the bus interface unit 309, the processor 302, or other hardware of the computer system 300.

The computer system 300 may include a bus interface unit 309 for communicating between the processor 302, the memory 304, a display system 324, and the I/O bus interface unit 310. The I/O bus interface unit 310 may be coupled with the I/O bus 308 for transferring data to and from the various I/O units. The I/O bus interface unit 310 may communicate with a plurality of I/O interface units 312, 314, 316, and 318, also known as I/O processors (IOPs) or I/O adapters (IOAs), via the I/O bus 308.

The display system 324 may include a display controller, a display memory, or both. The display controller may provide video, audio, or both types of data to the display device 326. Further, the computer system 300 may also include a device, such as one or more sensors, configured to collect data and provide the data to the processor 302.

For example, the computer system 300 may include biometric sensors that collect heart rate data, stress level data, and the like, environmental sensors that collect humidity data, temperature data, pressure data, and the like, and motion sensors that collect acceleration data, movement data, and the like. Other types of sensors may be used. The display system 324 may be connected to a display device 326, such as a single display screen, television, tablet, or portable device.

The I/O interface unit is capable of communicating with a variety of storage and I/O devices. For example, the terminal interface unit 312 supports the attachment of a user I/O device 320, which may include user output devices such as a video display device, a speaker, a television or the like, and user input devices such as a keyboard, mouse, keypad, touchpad, trackball, buttons, light pens, or other pointing devices or the like. A user may use the user interface to operate the user input device to input input data and instructions to the user I/O device 320 and the computer system 300 and receive output data from the computer system 300. The user interface may be presented via the user I/O device 320, such as displayed on a display device, played via a speaker, or printed via a printer.

The storage interface 314 supports the attachment of one or more disk drives or direct access storage devices 322 (which are typically magnetic disk drive storage devices, but may be arrays of disk drives or other storage devices configured to appear as a single disk drive). In some embodiments, the storage device 322 may be implemented as any secondary storage device. The contents of the memory 304 are stored in the storage device 322 and may be read from the storage device 322 as needed. The I/O device interface 316 may provide an interface to other I/O devices such as printers, fax machines, and the like. The network interface 318 may provide a communication path so that computer system 300 and other devices can communicate with each other. The communication path may be, for example, the network 330.

In some embodiments, the computer system 300 may be a multi-user mainframe computer system, a single user system, or a server computer or the like that has no direct user interface and receives requests from other computer systems (clients). In other embodiments, the computer system 300 may be a desktop computer, a portable computer, a notebook computer, a tablet computer, a pocket computer, a telephone, a smart phone, or any other suitable electronic device.

While embodiments of the present invention have been described above, the present invention is not limited to the above-described embodiments, and various changes can be made without departing from the spirit of the present invention.

### REFERENCE SIGNS LIST

100 Processor
101 Memory
102 Sensor group
103 Analysis unit
104 Priority determination unit
105 Countermeasure flow generation unit
106 Human resource dispatching unit
201 Event queue
202 Parameter calculation unit
203 Event Criticality determination unit
204 Convolutional neural network
205 First database
206 Surrounding impact determination unit
207 User input database
208 Static asset parameter calculation unit
209 Dynamic asset parameter calculation unit
210 Facility information database
211 Priority calculation unit
212 Neural network
213 Second database

What is claimed is:

1. A priority determination device for determining priority of an event, the priority determination device comprising:
a sensor group for acquiring sensor information;
an analysis unit for detecting, by analyzing the sensor information, occurrence of an event and determining an event feature related to the detected event;
a surrounding impact determination unit for determining, for an impact region that has a possibility of being impacted by the event, a surrounding impact parameter that indicates an impact of the event on the impact region based on the event feature related to the event; and
a priority calculation unit for determining a priority of the event based on at least the surrounding impact parameter.

2. The priority determination device according to claim 1, wherein the surrounding impact determination unit further comprises:
a static asset parameter calculation unit for calculating, for a facility in the impact region, a static asset parameter that indicates an importance of static assets of the facility; and
a dynamic asset parameter calculation unit for calculating, for a facility in the impact region, a dynamic asset parameter that indicates an importance of dynamic assets of the facility.

3. The priority determination device according to claim 2, further comprising:
a user input database for storing a situation information matrix that defines a context coefficient indicating, for each of an event type that indicates a type of the event, a degree of impact of the event with respect to a particular facility.

4. The priority determination device according to claim 3, wherein:
the surrounding impact determination unit determines the surrounding impact parameter using the static asset parameter, the dynamic asset parameter, the context coefficient determined from the situation information matrix, and a distance of the facility from the event.

5. The priority determination device according to claim 4, wherein:
the priority calculation unit determines the priority of the event based on the surrounding impact parameter and a criticality parameter that indicates a criticality of the event.

6. The priority determination device according to claim 5, wherein the priority calculation unit further comprises:
a countermeasure flow generation unit for generating, with respect to the priority of the event, a countermeasure flow for responding to the event.

7. A priority determination method for determining priority of an event, the priority determination method comprising:
a step of acquiring sensor information from a sensor group;
a step of detecting, by analyzing the sensor information, occurrence of an event and determining an event feature related to the detected event;
a step of calculating, for a facility in an impact region that has a possibility of being impacted by the event, a static asset parameter that indicates an importance of static assets of the facility based on the event feature related to the event;
a step of calculating a dynamic asset parameter that indicates an importance of dynamic assets of the facility based on the event feature related to the event;
a step of determining a context coefficient that defines a degree of impact of the event with respect to the facility from a situation information matrix stored in a user input database;
a step of determining a surrounding impact parameter that indicates an impact of the event on the impact region using the static asset parameter, the dynamic asset parameter, the context coefficient determined from the situation information matrix, and a distance of the facility from the event; and
a step of determining a priority of the event based on the surrounding impact parameter and a criticality parameter indicating a criticality of the event.

8. The priority determination method according to claim 7, further comprising:
a step of generating, with respect to the priority of the event, a countermeasure flow for responding to the event.

9. A priority determination system for determining priority of an event, the priority determination system comprising:
a sensor group for acquiring sensor information and a priority determination device for determining priority of an event that are connected via a communication network;
wherein the priority determination device comprises:
an analysis unit for detecting, by analyzing the sensor information received from the sensor group, occurrence of an event and determining an event feature related to the detected event;
a surrounding impact determination unit for determining, for an impact region that has a possibility of being impacted by the event, a surrounding impact parameter that indicates an impact of the event on the impact region based on the event feature related to the event; and
a priority calculation unit for determining a priority of the event based on at least the surrounding impact parameter.

10. The priority determination system according to claim 9, wherein:
the priority determination device further includes:
a user input database for storing a situation information matrix that defines a context coefficient indicating, for each of an event type that indicates a type of the event, a degree of impact of the event with respect to a particular facility; and
the surrounding impact determination unit is configured to:
include a static asset parameter calculation unit for calculating, for a facility in the impact region, a static asset parameter that indicates an importance of static assets of the facility;
include a dynamic asset parameter calculation unit for calculating, for a facility in the impact region, a dynamic asset parameter that indicates an importance of dynamic assets of the facility; and
determine the surrounding impact parameter using the static asset parameter, the dynamic asset parameter, the context coefficient determined from the situation information matrix, and a distance of the facility from the event.
